(19) United States
(12) Patent Application Publication
(10) Pub. No.: US 2024/0300211 A1
(43) Pub. Date: Sep. 12, 2024

(54) LAMINATED COMPOSITE COMPONENT

(71) Applicant: Acer Incorporated, New Taipei City (TW)

(72) Inventors: Dong-Sheng WU, New Taipei City (TW); Tzu-Wei LIN, New Taipei City (TW); Chih-Chun LIU, New Taipei City (TW); Cheng-Nan LING, New Taipei City (TW); Wen-Chieh TAI, New Taipei City (TW)

(73) Assignee: Acer Incorporated, New Taipei City (TW)

(21) Appl. No.: 18/582,234

(22) Filed: Feb. 20, 2024

(30) Foreign Application Priority Data
Mar. 6, 2023 (TW) 112201927

(51) Int. Cl. B32B 5/24; B32B 1/00; B32B 5/12; B32B 38/18

(52) U.S. Cl. CPC B32B 5/245; B32B 1/00; B32B 5/12; B32B 38/1866; B32B 2250/40; B32B 2262/106; B32B 2305/022; B32B 2307/7376

(57) ABSTRACT

A laminated composite component is provided in this disclosure. The laminated composite component comprises a foam material layer, a first laminated sheet group and a second laminated sheet group. The foam material layer has a first surface and a second surface opposite to each other. The first laminated sheet group is disposed on the first surface. The second laminated sheet group is disposed on the second surface. The first laminated sheet group includes a plurality of first sheets. The second laminated sheet group includes a plurality of second sheets. The foam material layer, the first sheets of the first laminated sheet group, and the second sheets of the second laminated sheet group are laminated and pressed to form in one piece.

This application claims the benefit of Taiwan application Serial No. 112201927, filed Mar. 6, 2023, the subject matter of which is incorporated herein by reference.

### TECHNICAL FIELD

The invention relates in general to a laminated composite component, and more particularly to a laminated composite component that can be used to form a casing of an electronic device.

### BACKGROUND

Currently, a casing of a laptop computer is mostly made of a magnesium alloy. Magnesium alloy has features regarding the density of 1.5 g/cm³ to 1.8 g/cm³ and a good rigidity. However, takes the magnesium-lithium alloy for example, a paint coating on a casing surface thereof is susceptible to damage because of the high activity of lithium metal. (Lithium is prone to oxidization when contacting the air).

Therefore, it has become a prominent task for the skilled in the art to provide a suitable material to meet requirements for a casing like light weight, high strength and easy shaping.

### SUMMARY

In view of the requirements for a casing in the prior art, a new type of laminated composite component that can be used to form a casing of an electronic device in one piece is provided in the present disclosure.

According to one embodiment of the present disclosure, a laminated composite component is provided. The laminated composite component comprises a foam material layer, a first laminated sheet group and a second laminated sheet group. The foam material layer has a first surface and a second surface opposite to each other. The first laminated sheet group is disposed on the first surface. The second laminated sheet group is disposed on the second surface. The first laminated sheet group includes a plurality of first sheets. The second laminated sheet group includes a plurality of second sheets. The foam material layer, the first sheet of the first laminated sheet group and the second sheet of the second laminated sheet group are laminated and pressed to form in one piece.

The above summary does not illustrate all possible embodiments of the present disclosure. Conversely, the above summary merely provides some embodiments illustrating the novelties and features of the present disclosure. For the embodiments, other purposes, technical features and advantages of the present invention to be more easily understood, a number of preferable embodiments are disclosed below in detail with the accompanying drawings. After referring to detailed descriptions of the embodiments made with the accompanying drawings, the skilled in the art will better understand other aspects of the present disclosure. The accompanying drawings are briefly described below.

### BRIEF DESCRIPTION OF THE DRAWINGS

The drawings are merely for illustrating the embodiments, not for limiting the embodiments or the scope of the claims:

FIG. 1 is a structural schematic diagram of a laminated composite component according to an embodiment of the present disclosure.

FIG. 2 is sectional view of a laminated composite component according to an embodiment of the present disclosure.

FIG. 3 is a schematic diagram of a recessed structure of a laminated composite component according to an embodiment of the present disclosure.

FIG. 4 is a sectional view of a mold for shaping a laminated composite component according to an embodiment of the present disclosure.

### DETAILED DESCRIPTION

Detailed descriptions of each embodiment of the present invention are disclosed below with reference to the accompanying drawings. Apart from the said detailed descriptions, any embodiments in which the present disclosure can be used as well as any substitutions, modifications or equivalent changes of the said embodiments are within the scope of the present disclosure, and the descriptions and definitions in the claims shall prevail.

Specific details and embodiments are disclosed in the specification for anyone ordinary skilled in the art to comprehensively understand the present disclosure, not for limiting the present disclosure. Moreover, generally known procedures or elements are not disclosed to avoid adding unnecessary restrictions to the present disclosure. Designations common to the accompanying drawings are used to indicate identical or similar elements. Unless otherwise specified, the accompanying drawings are for illustrating purpose only and are not necessarily based on actual sizes and scales.

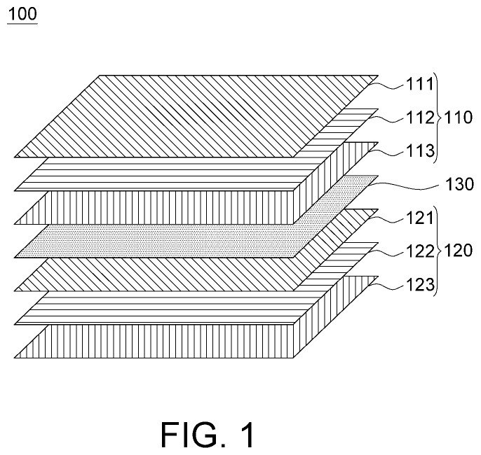

Referring to FIG. 1, a structural schematic diagram of a laminated composite component 100 according to an embodiment of the present disclosure is shown. The laminated composite component 100 can be used to form a casing of an electronic device, such as a casing of a laptop computer. As indicated in FIG. 1, the laminated composite component 100 comprises a first laminated sheet group 110, a second laminated sheet group 120 and a foam material layer 130. For example, the foam material layer 130 may be formed of a low-density polymer foam material.

The foam material layer 130 has a first surface and a second surface opposite to each other. The first surface and the second surface correspond to an upper surface and a lower surface. The first laminated sheet group 110 is disposed on the first surface of the foam material layer 130 and the second laminated sheet group 120 is disposed on the second surface of the foam material layer 130, so that the foam material layer 130 is interposed between the first laminated sheet group 110 and the second laminated sheet group 120 to be a core layer of the laminated composite component 100.

As indicated in FIG. 1, the first laminated sheet group 110 includes a plurality of first sheets, such as first sheets 111, 112, 113. The second laminated sheet group 120 includes a plurality of second sheets, such as second sheets 121, 122, 123. However, the present disclosure is not limited thereto. In other embodiments, the first laminated sheet group 110 or the second laminated sheet group 120 may include more layers of first sheets or second sheets based on actual needs. The foam material layer 130, the first sheets 111, 112, 113 and the second sheets 121, 122, 123 are laminated and pressed to form in one piece.

Specifically, each of the first sheets 111, 112, 113 or each of the second sheets 121, 122, 123 is a material formed of fiber tows arranged by a unidirectional arrangement. This material is also known as unidirectional material. For instance, when the fiber tows are carbon-fiber tows, the first sheets 111, 112, 113 and the second sheets 121, 122, 123 are made of unidirectional carbon fiber fabric.

As indicated in FIG. 1, the first sheets 111, 112, 113 may be materials arranged by a unidirectional arrangement along a fixed direction of different angles. That is, the first laminated sheet group 110 includes several layers of unidirectional fabric formed of fiber tows arranged along a fixed direction of different angles. Likewise, the second sheets 121, 122, 123 may also be materials arranged by a unidirectional arrangement along a fixed direction of different angles. That is, the second laminated sheet group 120 includes several layers of unidirectional fabric formed of fiber tows arranged along a fixed direction of different angles.

For instance, the first sheets 111, 112, 113 are formed of an unidirectional material at an angle of 0°, 60° and 120° respectively then are laminated according to a specific order to form the first laminated sheet group 110, and so are the second sheets 121, 122, 123 formed of an unidirectional material at an angle of 0°, 60° and 120° respectively then are laminated according to a specific order to form the second laminated sheet group 120. Thus, by laminating the unidirectional materials arranged by a fixed direction of different angles, the laminated composite component 100 has the advantages of maintained flatness and increased strength.

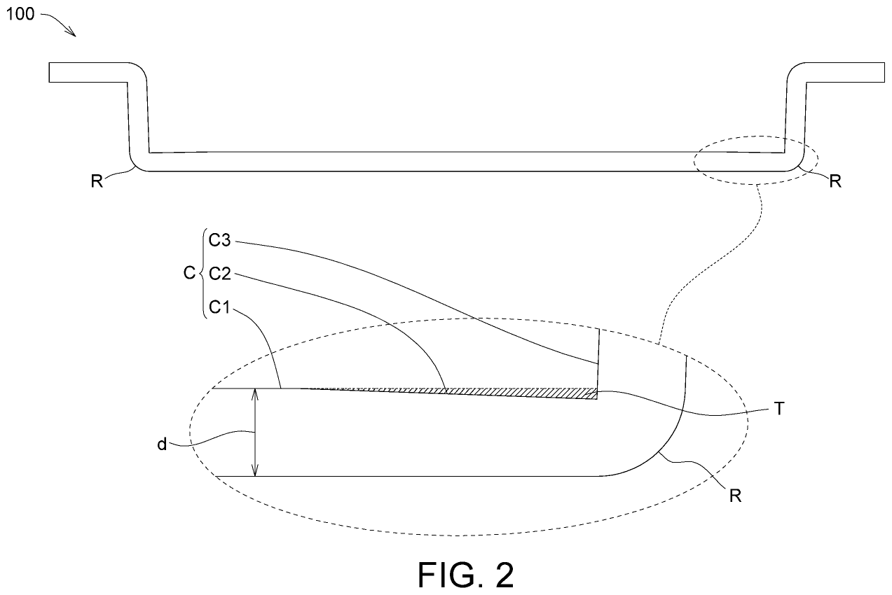

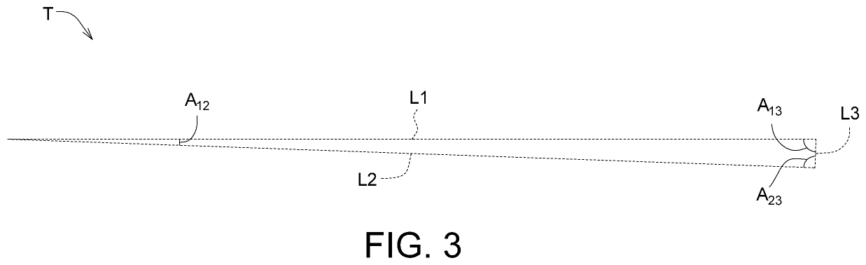

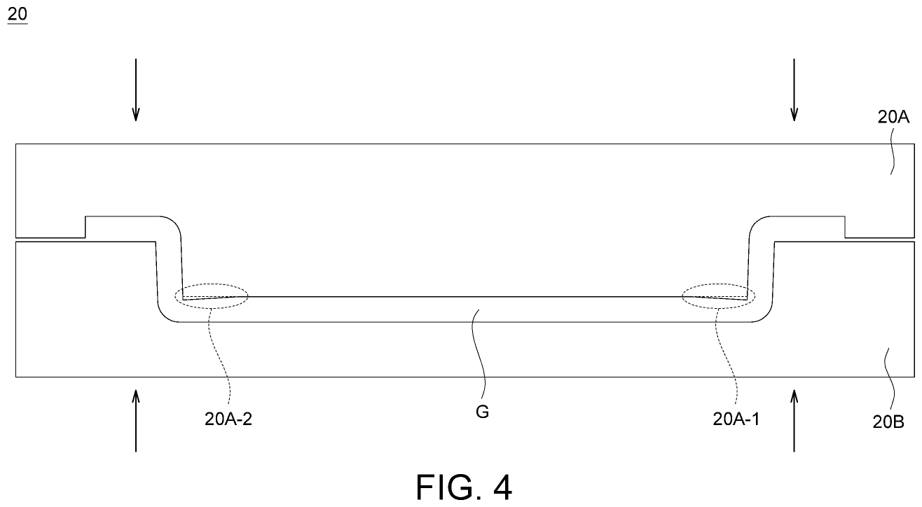

Referring to FIG. 2, FIG. 3 and FIG. 4. FIG. 2 is a sectional view of the laminated composite component 100 according to an embodiment of the present disclosure. FIG. 3 is a schematic diagram of a recessed structure of the laminated composite component 100 according to an embodiment of the present disclosure. FIG. 4 is an sectional view of a mold for shaping the laminated composite component 100 according to an embodiment of the present disclosure. The laminated composite component 100 may be processed with hot-pressing molding by a mold 20 shown in FIG. 4 to form the shape shown in FIG. 2.

For instance, the laminated composite component 100 is processed with hot-pressing molding by the mold 20 to form a thickness d of 0.8 mm, so that the overall density of the laminated composite component 100 is less than 1 g/cm³. The laminated composite component 100 is processed with hot-pressing molding by the mold 20 to form a curved structure R and a recessed structure C opposite to the curved structure R. For instance, the curved structure R is a curve fillet with a radius of 1 mm.

As indicated in FIG. 2, the recessed structure C includes a first lateral side C1, a second lateral side C2 and a third lateral side C3. The first lateral side C1 is connected to the third lateral side C3 through the second lateral side C2. That is, a bending part on the inner side of the laminated composite component 100 is a recessed structure C with multiple lateral sides rather than a general rectangular structure. In the sectional view of FIG. 2, the first lateral side C1 can extend as a dotted line to form a triangular area T together with the second lateral side C2 and the third lateral side C3. As indicated in FIG. 3, the triangular area T has a first lateral side L1, a second lateral side L2 and a third lateral side L3. The first lateral side L1 corresponds to the dotted line as extended by the first lateral side C1. The second lateral side L2 corresponds to the second lateral side C2. The third lateral side L3 corresponds to the third lateral side C3.

As indicated in FIG. 3, the first lateral side L1 and the second lateral side L2 form an included angle A₁₂. The first lateral side L1 and the third lateral side L3 form an included angle A₁₃. The second lateral side L2 and the third lateral side L3 form an included angle A₂₃. In an exemplary embodiment, the included angle A₁₂ is such as 0.9°, the included angle A₁₃ is such as 87.4°, and the included angle A₂₃ is such as 91.7°. That is, the included angles formed by any two of the first lateral side C1, the second lateral side C2 and the third lateral side C3 are not equal to one another. In the triangular area T of the exemplary embodiment disclosed above, a length of the first lateral side L1 is 5.08 mm, a length of the second lateral side L2 is 5.077 mm, and a length of the third lateral side L3 is 0.081 mm.

As indicated in FIG. 4, the mold 20 by which the laminated composite component 100 is processed with hot-pressing molding includes a male mold portion 20A and a female mold portion 20B, wherein the female mold portion 20B can be used to accommodate the laminated composite component 100, so that the male mold portion 20A can be used to perform hot-pressing molding to form the shape as present by the gap G. The male mold portion 20A may have mold plane structures 20A-1 and 20A-2 corresponding to the shape of the triangular area T as indicated in FIG. 2 and FIG. 3. Thus, after the laminated composite component 100 is processed with hot-pressing molding by the mold 20, the laminated composite component 100 can form the said recessed structure C. Besides, through the design of the mold plane structures 20A-1 and 20A-2 of the male mold portion 20A, the complete curved structure R of the laminated composite component 100 may be formed. As such, defects due to lack of glue occurring at a bending part of the curved structure R can be avoid during the hot-pressing molding process, and thus the yield rate of hot-pressing molding process can be increased.

According to the embodiments of the present disclosure, a laminated composite component and a mold by which the laminated composite component is processed with hot-pressing molding are provided. The mold by which hot-pressing molding is processed has a specially designed mold plane structure, which provides the laminated composite component with a recessed structure and further avoids defects due to lack of glue occurring at the bending part of the laminated composite component. Moreover, the laminated composite component of the present disclosure may be formed of a carbon fiber composite material, which outdoes the metal material, which forms the casing of an electronic device, in terms of tensile strength and bending strength. Additionally, in comparison to the conventional combinational material formed of a planar sheet and plastic edges, the laminated composite component of the present disclosure is easier to be processed in three-dimensional shaping, forms the casing of an electronic device in one piece and has the advantage of light weight.

While the invention has been described by way of example and in terms of the preferred embodiment(s), it is to be understood that the invention is not limited thereto. Based on the technical features embodiments of the present disclosure, a person ordinarily skilled in the art will be able to make various modifications and similar arrangements and procedures without breaching the spirit and scope of protection of the invention. Therefore, the scope of protection of the present disclosure should be accorded with what is defined in the appended claims.

What is claimed is:

1. A laminated composite component, comprising:
a foam material layer having a first surface and a second surface opposite to each other;
a first laminated sheet group disposed on the first surface, wherein the first laminated sheet group comprises a plurality of first sheets; and
a second laminated sheet group disposed on the second surface, wherein the second laminated sheet group comprises a plurality of second sheets, and the foam material layer, the first sheets and the second sheets are laminated and pressed to form an integral whole.

2. The laminated composite component according to claim 1, wherein each of the first sheets is formed of fiber tows arranged by a unidirectional arrangement.

3. The laminated composite component according to claim 2, wherein the fiber tows are carbon-fiber tows.

4. The laminated composite component according to claim 2, wherein the first sheets are materials arranged by a unidirectional arrangement along a fixed direction of different angles.

5. The laminated composite component according to claim 4, wherein the fiber tows are carbon-fiber tows.

6. The laminated composite component according to claim 1, wherein each of the second sheets is formed of fiber tows arranged by unidirectional arrangement.

7. The laminated composite component according to claim 6, wherein the fiber tows are carbon-fiber tows.

8. The laminated composite component according to claim 6, wherein the second sheets are materials arranged by a unidirectional arrangement along a fixed direction of different angles.

9. The laminated composite component according to claim 8, wherein the fiber tows are carbon-fiber tows.

10. The laminated composite component according to claim 1, wherein the laminated composite component is processed with a hot-pressing molding to form a curved structure.

11. The laminated composite component according to claim 10, wherein the curved structure has a curve fillet with a radius of 1 mm.

12. The laminated composite component according to claim 10, wherein the laminated composite component is processed with the hot-pressing molding to form a recessed structure opposite to the curved structure, the recessed structure includes a first lateral side, a second lateral side and a third lateral side, the first lateral side is connected to the third lateral side through the second lateral side, and included angles formed by any two of the first lateral side, the second lateral side and the third lateral side are not equal to one another.

13. The laminated composite component according to claim 1, wherein the laminated composite component is processed with a hot-pressing molding to form a thickness of 0.8 mm.
